(19) United States
(12) Patent Application Publication
(10) Pub. No.: US 2008/0306936 A1
(43) Pub. Date: Dec. 11, 2008

(54) Method and apparatus for compiling user preferences for digital content streamed to a mobile handset

(75) Inventors: Edwin Ho, Palo Alto, CA (US); King Sun Wai, Castro Valley, CA (US); Jie Lin, San Francisco, CA (US)

Correspondence Address: DLA PIPER US LLP, 2000 UNIVERSITY AVENUE, E. PALO ALTO, CA, 94303-2248, US

(73) Assignee: MSpot, Inc.

(21) Appl. No.: 11/810,936

(22) Filed: Jun. 6, 2007

(51) Int. Cl. G06F 17/30

(52) U.S. Cl. 707/5; 707/E17.001

(57) ABSTRACT

A method and apparatus for compiling user preferences and providing access to preferred digital content on a mobile handset is provided.

### FIELD OF THE INVENTION

The invention relates generally to a method and apparatus for providing video, audio, or other digital content to a mobile handset.

### BACKGROUND OF THE INVENTION

In recent years, mobile handsets (such as cellular phones and PDAs) have become more powerful and now offer additional functionality beyond just voice communication. For instance, many mobile handset devices today allow users to perform web browsing on the Internet, receive emails, and play video and audio content streamed from over a wireless network. Such devices contain increasingly powerful processors and enhanced video and audio capability. However, their storage capacity is generally much smaller than the capacity of PCs and notebook computers. As a result, users of mobile handsets are reliant upon video and audio content that is streamed rather than downloaded and stored permanently. In addition, the relatively small screen and buttons on a mobile handset result in a user interface that is more tedious for a user than when compared to a user interface on a typical PC. It is desirable from a user's perspective to be able to access the desired content with as few clicks or keystrokes as possible.

The Apple iPod™ is a popular consumer electronic device that stores music locally and allows the user to listen to it. The user is able to provide a rating for a particular song on the iTunes software application on a PC that is intermittently synchronized with the iPod. For example, if the PC contains the song “Hey Jude,” then the user is able to provide it a rating of between one to five stars. That rating is transferred to the iPod when it is synchronized with the PC. Through this method, the user is able to rate the songs on his or her iPod and can compile playlists consisting of his or her most favorite songs based on the ratings, which enables the user to more quickly access those favorite songs.

For other mobile handsets that are not synchronized with PCs, however, the above-describe method would be a tedious and laborious process. Due to the size constraints of a mobile device, it would take a substantially greater amount of time for a user to rate songs individually on a mobile handset as opposed to on a PC. Thus, what is needed is an improved method and apparatus for creating a compilation of user preferences with as little user intervention as possible.

### SUMMARY OF THE INVENTION

In accordance with the invention, a method and apparatus are provided to create a compilation of user preferences of content available on or through the mobile handset and to provide access to the preferred content and to other content sharing characteristics similar to that of the preferred content.

### BRIEF DESCRIPTION OF THE DRAWINGS

FIG. 1 is a block diagram of a mobile handset device service system;

FIG. 2A illustrates an example of the user interface of a mobile handset device that graphically shows a “my favorites” feature.

FIG. 2B illustrates another example of the user interface of a mobile handset device that graphically shows a “my favorites” feature.

FIG. 3 is a flow chart depicting an embodiment for creating a compilation of a user's preferences of content on or through the mobile handset.

### DETAILED DESCRIPTION OF A PREFERRED EMBODIMENT

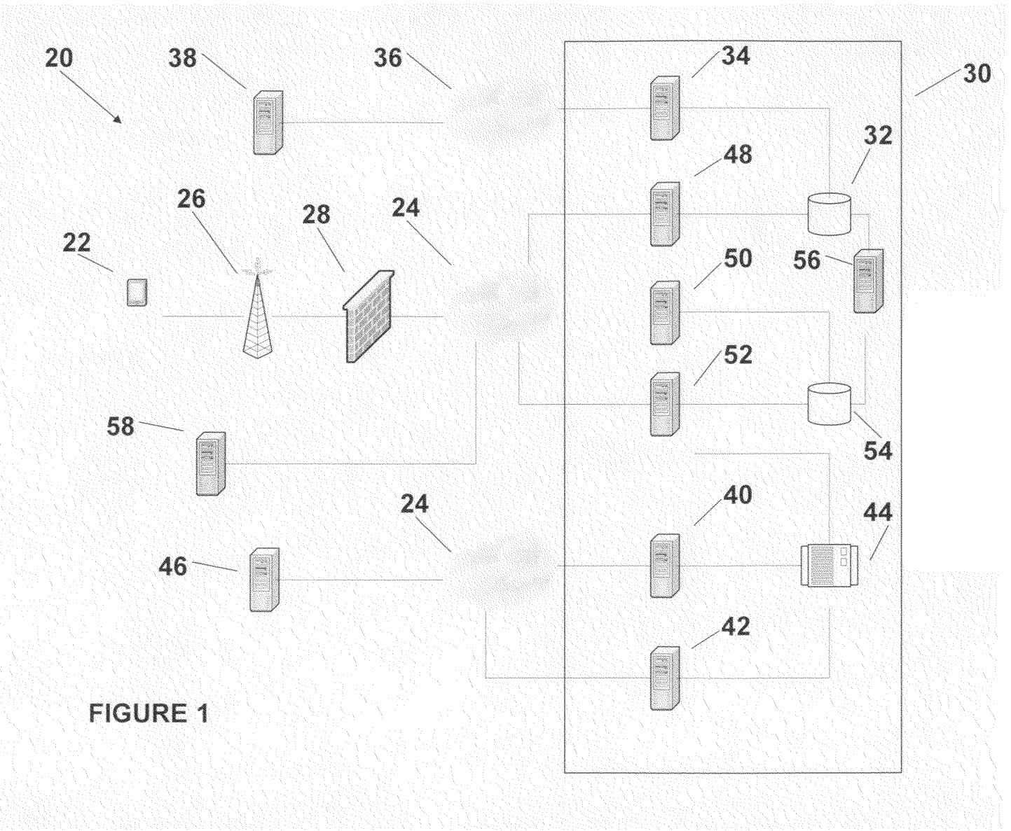

FIG. 1 depicts a typical mobile handset service system 20. The mobile device service system 20 provides one or more services, such as movies, videos, sports information, music, etc. to a mobile handset 22. Mobile handset 22 may include a client application, such as a JAVA piece of code, that processes the incoming service data and displays the service data to the user of the mobile device. The mobile handset 22 may be any processing unit based device that has sufficient processing power, memory, display and connectivity capabilities to execute the client application, receive the service data and display that service data. For example, the mobile device may be a PDA, mobile phone, or wireless email device (such as the Blackberry). In the example shown in FIG. 1, the mobile device 22 couples to a communications link 24, such as the Internet, over a wireless network 26 and a firewall 28. The mobile handset service system 20 also has a service unit 30 that performs various function and operations for the mobile handset service system.

The service unit 30 may include a user information storage unit 32 that stores information about each user of the mobile handset service system including user billing information and user service personalization information. The service unit 30 may also have a billing server 34 that performs a billing operation for the services provided to the user. In the example shown in FIG. 1, the billing for the services are communicated over a secure link 36, such as a secure socket layer (SSL) connection, to a carrier billing system 38 so that the mobile device carrier can provide the bill for the services on the monthly invoice of the user of the mobile device. Alternatively, the service unit 30 can directly bill the user. The service unit 30 may also include a live content ingester 40, a clip digester 42 and a content/asset storage unit 44 that handle the service content (such as music, movies, etc.) from a third party 46 that will be delivered by the mobile handset service system. The live content ingester receives any live content and processes it and then stores the live content in the content/asset storage unit 44 in various output encoding and file formats. The clip digester 42 receives non-live content and data, processes it and then stores the clips in the storage unit 44 in various output encoding and file formats.

The service unit 30 may further include a menu/personalization unit 48, a reporting unit 50, a streaming unit 52, a log database 54 and a data mining unit 56. The menu/personalization unit 48, the reporting unit 50, the streaming unit 52 and the data mining unit 56 may preferably each be server computers. The menu/personalization unit generates and delivers the mobile device service user interfaces to the user that may also be customized by the user based on the customization information stored in the user information storage unit 32. The streaming unit may preferably support the real-time streaming protocol (RTSP) and the hypertext transfer protocol (HTTP) and may deliver/stream the service content to the mobile device over the link 24. The streaming unit may request the service content from the content store 44 and may store service content information in the log store 54. The reporting unit 50 may generate a report about various aspects of the service unit and its operations. The data mining unit 56 collects user behavior information which is then mined to determine any recommendations and personalizations for users of the system.

A user of mobile handset 22 can run various applications on the handset, such as an application that enables the user to listen to music, an audiobook or eBook, or other audio programming or to watch a movie, TV show, or other video content streamed from streaming unit 52. A user also can access Internet content, such as a website. In one embodiment of the invention, menu/personalization unit 48 keeps track of a user's actions on the mobile handset. For example, it can create a database record which tracks the audio content (e.g., songs, RSS feeds, podcasts, programs, radio stations, etc.) that the user listens to, the date and time that the user listened to it, the duration, etc. It also can track websites visited, video content viewed, etc. Menu/personalization unit 48 can then create data to be used by mobile handset 22 to create a user interface icon or link that allows the user to easily access the content that menu/personalization unit 48 has determined to be preferred by the user based on the user's past actions. For example, it can create a folder that contains links to a favorite radio station, a favorite website, a favorite set of information (e.g., the weather in Denver, Colo.), etc. This minimizes the amount of clicks, keystrokes, etc. that a user must engage in before accessing the desired content.

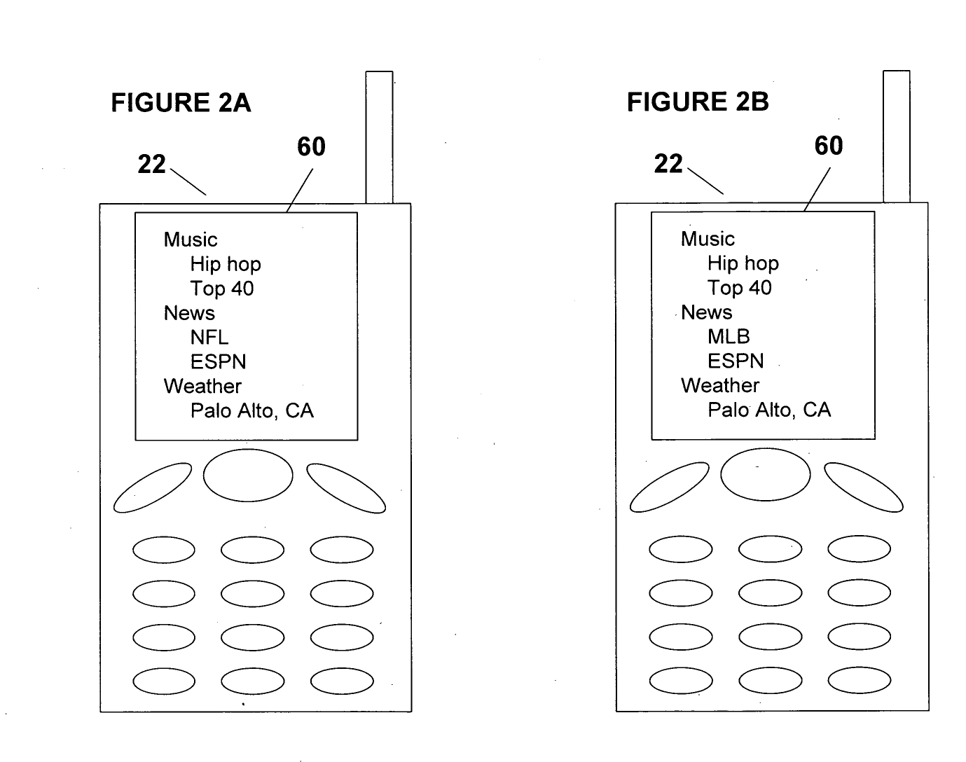

Referring now to FIG. 2A, mobile handset 22 is shown in greater detail. It is to be understood that FIG. 2A is exemplary and that an embodiment need not be limited to the particular aesthetic or functional features displayed in FIG. 2. Mobile handset 22 includes a video display 60. Mobile handset 22 includes a speaker (not shown) that generates audio content. Thus, a user of mobile handset 22 can watch video content of video display 60 and listen to audio content through a speaker. In FIG. 2A, video display 60 shows an exemplary user interface for one embodiment of the invention. The video display 60 shows the contents of a “My Favorites” folder that allows the user to quickly access his or her favorite content. The data used to create this interface is transferred to mobile handset 22 by menu/personalization unit 48. The “My Favorites” folder contains links for music, news, and weather. These topics are exemplary only. Thus, menu/personalization unit 48 has previously determined that “hip hop” and “Top 40” are favorite music types/radio stations of the particular user, that NFL and ESPN are two sources of favorite news, and that the user prefers to learn about the weather in Palo Alto, Calif.

Referring now to FIG. 2B, the same mobile handset 22 is displayed. However, based on the user's activities, the contents of the “My Favorites” folder have now changed. In this example, because the NFL (football) season has ended and the MLB (baseball) season has begun, the user no longer views or listens to news about the NFL and has started to view or listen to news about MLB. Menu/personalization unit 48 has logged this change in behavior, and at some point during the sequence of user activity, the user's preference for MLB news overrides his previous preference for NFL news, and the contents of “My Favorites” changes from NFL news to MLB news. Preferably, this change does not occur with the very first time that the user selects MLB news, because that single instance may be a one-time occurrence. Rather, menu/personalization unit 48 will look for a pattern of behavior based on the weighting process described in more detail below.

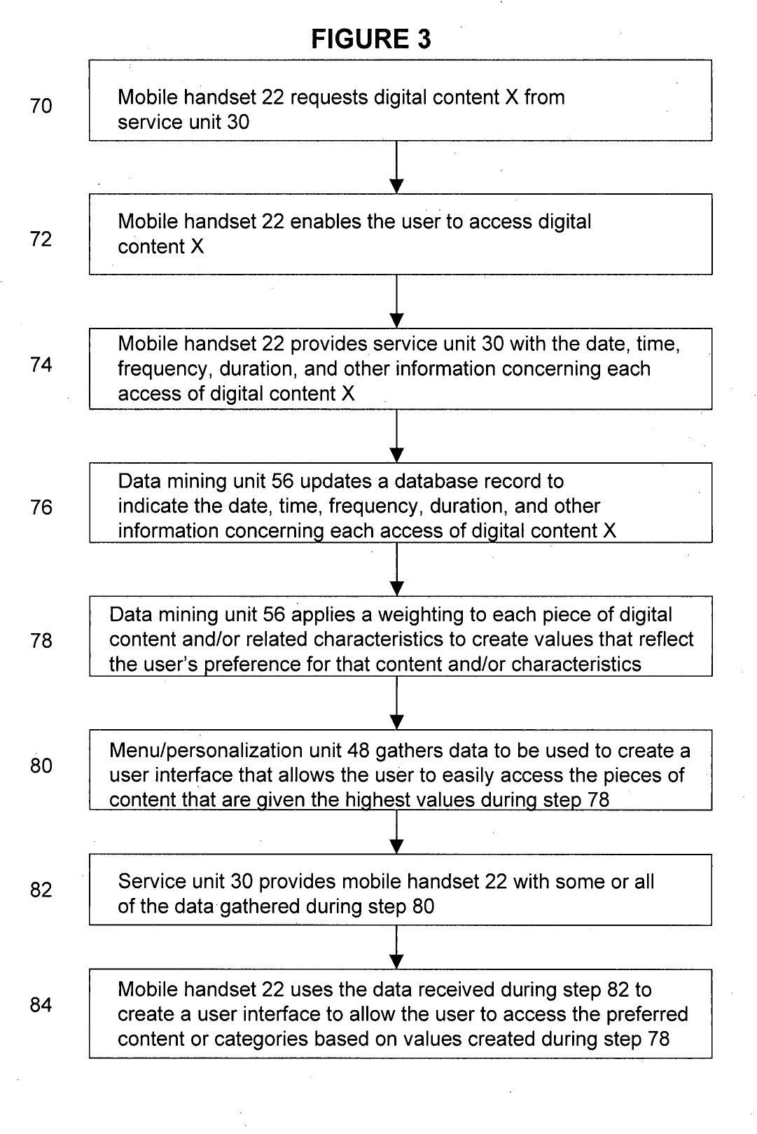

Referring now to FIG. 3, an embodiment by which user preferences are compiled is shown. Mobile handset 22 requests digital content X from service unit 30 (70). Digital content X might be a website, an audio song, video movie, radio station, etc. Mobile handset 22 enables the user to access digital content X (72). Mobile handset 22 provides service unit 30 with information concerning the user's actions concerning digital content X, such as the date, time, frequency, and duration of each access of digital content X (74). Data mining unit 56 updates a database record to indicate the user's actions concerning digital content X, such as the date, time, frequency, and duration of each access of digital content X (76). The database record also may include information concerning characteristics of digital content X. For example, if digital content X is an audio song, then the database record might be populated with characteristics such artist, album name, music genre, year of release, record label, etc. Optionally, data mining unit 56 applies a weighting to each piece of digital content and/or to characteristics to create values for each piece and/or characteristics that reflects the user's preference for that content (e.g., a particular song) or content that share those characteristics (e.g., songs within the same genre as the particular song, such as hip hop) (78). Menu/personalization unit 48 gathers data to be used to create a user interface that allows the user to easily access the preferred pieces of content and/or content that shares characteristics with the preferred pieces of content based upon the values generated during step 78 (80). The data might comprise a list of favorites, such as websites, songs, artists, movies, radio stations, etc. Service unit 30 provides mobile handset 22 with some or all of the data gathered during step 80 (82). Mobile handset 22 uses the data received during step 82 to create a user interface (such as, for example, the user interface depicted in FIG. 2) to allow the user to access the preferred pieces of content and/or the preferred categories of content based on the values generated during step 78 (84).

The weighting process (78) can take into account characteristics such as frequency of access to the content (or other content from the same genre), the duration of the access, the date and time of the access, or any other patterns in the user's behavior as to that content (or other content from the same genre). For example, one possible formula is the following: VALUE=X*Duration of Total Listening Time of Relevant Content (e.g., number of seconds of listening to hip hop music)−Y*Duration of Total Listening Time of Other Content Since Last Access to Relevant Content (e.g., the amount of time spent listening to other content since the last time the user listened to hip hop music). The values of X and Y are chosen by the operator of menu/personalization unit 48. The purpose of weighting process (78) is to generate a value that is indicative of whether the particular content is a “favorite” of the user. Preferably, it reflects more than just the most recent content accessed. Because menu/personalization unit 48 is able to track the activity of mobile handset 22, it is able to identify patterns in the user's behavior and create a menu of the user's favorite content.

Another embodiment for weighting process (78) would be to create a value that reflects the total number of accesses to the content by mobile handset 22 over a certain time period (or since the first use of the mobile handset 22), or to create a value that reflects the total number of accesses to the content or to other content sharing similar characteristics (such as all songs by the same artist) over a certain time period (or since the first use of mobile handset 22), or to create some combination of the two aforementioned values.

While the foregoing has been with reference to particular embodiments of the invention, it will be appreciated by those skilled in the art that changes in these embodiments may be made without departing from the principles and spirit of the invention, the scope of which is defined by the appended claims.

1. A method for compiling user preferences and providing access to digital content, comprising the steps of:
creating a database record of access by a mobile handset to one or more pieces of digital content over a network;
applying a weighting against some or all of said pieces of digital content to create a list of preferred digital content;
generating a user interface on said mobile handset to enable access to digital content on said list.

2. The method of claim 1, wherein at least one of said pieces of digital content is audio content.

3. The method of claim 1, wherein at least one of said pieces of digital content is video content.

4. The method of claim 1, wherein at least one of said pieces of digital content is website content.

5. The method of claim 1, wherein said weighting reflects frequency of access by said mobile handset to said pieces of digital content.

6. The method of claim 5, wherein said weighting further reflects the date and time of the last access by said mobile handset to said pieces of digital content.

7. A method for compiling user preferences and providing access to digital content and other digital content with shared characteristics, comprising the steps of:
creating a database record of access by a mobile handset to one or more pieces of digital content over a network;
populating the database record with characteristics of said one or more pieces of digital content;
applying a weighting against some or all of contents of said database record to create a list of preferred digital content and characteristics;
generating a user interface on said mobile handset to enable access to digital content on said list and one or more pieces of digital content sharing a characteristic on said list.

8. The method of claim 7, wherein at least one of said pieces of digital content is audio content.

9. The method of claim 7, wherein at least one of said pieces of digital content is video content.

10. The method of claim 7, wherein at least one of said pieces of digital content is website content.

11. The method of claim 8, wherein one of said characteristics is artist name.

12. The method of claim 8, wherein one of said characteristics is music genre.

13. The method of claim 7, wherein said weighting reflects frequency of access by said mobile handset to said pieces of digital content.

14. The method of claim 7, wherein said weighting further reflects the date and time of the last access by said mobile handset to said pieces of digital content.

15. An apparatus for compiling user preferences and providing access to preferred digital content, comprising:
a storage unit containing a database record of access by a mobile handset to one or more pieces of digital content over a network;
a server associated with said storage unit programmed for applying a weighting against said one or more pieces of digital content to create a list of preferred digital content; and
said server further programmed to transmit data to generate a user interface on said mobile handset to enable access to digital content on said list.

16. The apparatus of claim 15, wherein at least one of said pieces of digital content is audio content.

17. The apparatus of claim 15, wherein at least one of said pieces of digital content is video content.

18. The apparatus of claim 15, wherein at least one of said pieces of digital content is website content.

19. The apparatus of claim 15, wherein one of said characteristics is artist name.

20. The apparatus of claim 15, wherein one of said characteristics is music genre.

21. The apparatus of claim 15, wherein said weighting reflects frequency of access by said mobile handset to said pieces of digital content.

22. The apparatus of claim 15, wherein said weighting further reflects the date and time of the last access by said mobile handset to said pieces of digital content.

23. An apparatus for compiling user preferences and providing access to preferred digital content, comprising:
a storage unit containing a database record of access by a mobile handset to one or more pieces of digital content over a network;
a server associated with said storage unit programmed for populating the database record with characteristics of said one or more pieces of digital content;
said server further programmed for applying a weighting against said one or more pieces of digital content and one or more of said characteristics to create a list of preferred digital content and characteristics; and
said server further programmed to transmit data to generate a user interface on said mobile handset to enable access to digital content on said list and digital content sharing a characteristic on said list.

24. The apparatus of claim 20, wherein at least one of said pieces of digital content is audio content.

25. The apparatus of claim 20, wherein at least one of said pieces of digital content is video content.

26. The apparatus of claim 20, wherein at least one of said pieces of digital content is website content.

27. The apparatus of claim 21, wherein one of said characteristics is artist name.

28. The apparatus of claim 21, wherein one of said characteristics is music genre.

29. The apparatus of claim 20, wherein said weighting reflects frequency of access by said mobile handset to said pieces of digital content.

30. The apparatus of claim 20, wherein said weighting further reflects the date and time of the last access by said mobile handset to said pieces of digital content.
